(19) United States
(12) Patent Application Publication
(10) Pub. No.: US 2013/0081250 A1
(43) Pub. Date: Apr. 4, 2013

(54) SPRINKLER FITTING ATTACHMENT DEVICE

(71) Applicants: Wayne R. JOHNSTON, San Marcos, CA (US); Alan G. JOHNSTON, Nashua, NH (US)

(72) Inventors: Wayne R. JOHNSTON, San Marcos, CA (US); Alan G. JOHNSTON, Nashua, NH (US)

(73) Assignee: THE WANDA GROUP, Nashua, NH (US)

(21) Appl. No.: 13/251,877

(22) Filed: Oct. 3, 2011

(51) Int. Cl. B23P 11/00; F16L 5/00

(52) U.S. Cl. 29/428; 137/357

(57) ABSTRACT

Apparatus and methods for attachment of a fire protection sprinkler fitting to the wall-ceiling junction of existing buildings. In a J-fitting assembly of a sprinkler system is coupled to a water supply and has an exposed sprinkler head connected to it, the attachment apparatus includes a guide channel coupled to the J-fitting to facilitate fastening the fitting to the internal structure of the wall.

### FIELD OF INVENTION

The present application relates generally to the field of fire protection for buildings such as residences and offices, among others, and more particularly to a fire protection sprinkler system and an attachment device which allows installation of the fire protection sprinkler system into existing buildings.

### BACKGROUND OF THE INVENTION

A major and ongoing challenge in the field of fire protection systems for buildings such as residences, office buildings and commercial buildings, is to find a way add adequate fire protection methods and apparatus to existing buildings which were constructed with no or with inadequate fire protection systems and to add these methods and apparatus in a manner which is both cost effective and which produces an attractive and operationally effective end product. Longstanding concerns for the retrofitting procedures which have previously been used are possible damages to walls, ceilings, and floors created during the process. The most widely used method for retrofitting an existing building involves the invasive and destructive opening up of existing walls, ceilings, and floors to allow the installation of sprinkler piping and its associated apparatus. When they occur, the resultant damages to the building areas are costly to ameliorate and to restore them to their original condition. In some cases, complete restoration may not be possible.

The costs associated with restoration are often prohibitive for residential buildings and, as a result, fire protection contractors have focused their business on commercial constructions where larger budgets are generally available. This has left large numbers of homeowners without the availability of adequate fire protection retrofitting. This has had an adverse effect on the safety of homeowners and also on the costs of fire insurance for those homeowners. However, in recent years, apparatus and methods for cost effective retrofitting of existing residential buildings have been developed. One such method and apparatus is described in U.S. Pat. No. 7,699,117, which discloses a unitary, pre-assembled sprinkler fitting assembly. This apparatus provides a fire protection system comprising a water line and provisions for installing conventional fire protection sprinkler heads at or near the joint between the walls and ceiling of rooms in an existing residential building and concealing this apparatus behind conventional crown molding.

A desirable feature of any fire protection system which is to be retrofitted into an existing residence is that it can be installed in a clean, reliable manner resulting in a permanent, secure, and rigid end product which will provide dependable performance and require minimal maintenance after installation. Heretofore, this requirement has necessitated a great deal of customization to adapt the protection system to the contours, dimensions, shapes, and detailed construction of the existing building into which it is being installed. This process, in turn, requires extensive labor costs. In addition, significant variability between the methods selected by different installers can make service of retrofitted installations by persons other than the original retrofitter difficult and costly.

### SUMMARY OF EMBODIMENTS OF THE INVENTION

Accordingly, it is a purpose of embodiments of the present invention to provide a sprinkler fitting attachment device and installation method which improves the known methods of installing pre-assembled, unitary sprinkler fitting assemblies such as those disclosed in U.S. Pat. No. 7,699,117.

The sprinkler fitting assembly of the '117 patent is a fire protection apparatus for installation in a space having at least one wall and a ceiling in adjacent relationship therewith forming a wall/ceiling junction, the wall having a first side and a second side spaced from the first side and defining an internal space there between, and having a first hole adjacent the wall/ceiling junction in the first side and a second hole spaced from the first hole in the first side, the apparatus comprising: a fluid transporting pipe positioned adjacent the wall/ceiling junction external to the first side of the wall; and a unitary, pre-assembled fitting shaped and configured to reside within the wall internal space with a first end extending into the first hole in the wall and a second end extending into the second hole in the wall, the second end being configured to receive a sprinkler head, the first end having a coupling configured to engage at least one end of the pipe for fluid communication from the pipe to the second end of said fitting.

The following summary of the invention is provided to enable an understanding of some of its novel features but is not intended to be a full description. A full appreciation of the aspects of the various embodiments will be provided by the entire specification, claims, drawings, and abstract as a whole.

A purpose of embodiments of the invention is to provide an attachment device which improves upon the permanence, rigidity, and securing of sprinkler fitting assemblies which are to be retrofitted into an existing residence.

A further feature of the embodiments is to provide a sprinkler fitting attachment device which is more compact and efficient than known devices.

Another feature of embodiments of the invention is to provide a sprinkler fitting attachment device that integrates readily with existing installation procedures.

Still another feature of the embodiments is to provide a sprinkler fitting attachment device that itself is securely, rigidly, and permanently attached directly to the building structure.

Another feature of the embodiments is that it enables the improvement of the alignment of a sprinkler adapter outlet of a sprinkler fitting assembly within an aperture created in an existing wall of a residence during the installation process.

Another purpose of the invention is to provide an improved aesthetic appearance of a retrofitted fire protection system installation by concealing a completed configuration including piping, the sprinkler fitting assembly, the sprinkler fitting attachment device, and any apertures in the building structure required for the installation behind conventional crown molding.

### BRIEF DESCRIPTION OF THE DRAWING

The objects, advantages, features, and other desirable characteristics of embodiments of the invention can be readily perceived from the following detailed description when read in conjunction with the accompanying drawing, wherein:

FIG. 1 is a top view of a prototype sprinkler fitting attachment device according to an embodiment of the invention, showing the device attached to a sprinkler fitting assembly;

FIG. 2 is a front view of the device shown in FIG. 1 attached to a sprinkler fitting assembly;

FIG. 3 is a cross sectional side view of the assembly shown in FIGS. 1 and 2 and installed within a wall cavity;

FIG. 4 is an isometric view of the apparatus shown in FIG. 3;

FIG. 5 is an exploded isometric view of the installation of FIG. 3;

FIG. 6 is a side view of the installation shown in FIG. 3;

FIG. 7 is a top view of the attachment device of FIG. 1;

FIG. 8 is a front view of the attachment device of FIG. 7;

FIG. 9 is a cross sectional side view of attachment device showing an exemplary installation;

FIG. 10 is an isometric view of the attachment device of FIGS. 7 and 8;

FIG. 11 is a top view of a molded version of the attachment device attached to a sprinkler fitting assembly;

FIG. 12 is a front view of the assembly shown in FIG. 11;

FIG. 13 is a cross sectional side view of the assembly of FIGS. 11 and 12 installed within a wall cavity;

FIG. 14 is an isometric view of a the assembly of FIGS. 11-13;

FIG. 15 is an enlarged side view of the attachment device shown in FIG. 1, defining segments 1, 2, and 3 of the device fabricated from pipe materials such as copper;

FIG. 16 is an enlarged side view of a molded version of the attachment device of FIG. 11, defining segments 1, 2, and 3 of a device fabricated from molded plastic materials;

FIG. 17 is a top view of a molded version of the attachment device of FIG. 11;

FIG. 18 is a front view of the device of FIG. 17;

FIG. 19 is a cross sectional side view of the attachment device showing an exemplary installation;

FIG. 20 is an isometric view of the attachment device of FIGS. 17 and 18;

FIG. 21 is a sprinkler fitting assembly similar to that disclosed in U.S. Pat. No. 7,699,117;

FIG. 22 is an isometric view of a molded version of the attachment device as viewed from inside a room in which it is used to install a sprinkler fitting assembly, showing its relationship to the interior and exterior planes of the wall surfaces;

FIG. 23 is an isometric view of the attachment device from inside the wall shown in FIG. 22, showing its relationship to the exterior and interior planes of the wall surfaces;

FIG. 24 is an exploded isometric view of the attachment device as shown in FIG. 22;

FIG. 25 is a top view of a first section of an alternative embodiment of the attachment device in accordance with an embodiment of the invention;

FIG. 26 is a front view of the device shown in FIG. 25;

FIG. 27 is a side view of the device shown in FIG. 25;

FIG. 28 is an isometric view of the device shown in FIG. 25;

FIG. 29 is a top view of a second section of the alternative embodiment of the attachment device of FIG. 25;

FIG. 30 is a front view of the device as shown in FIG. 29;

FIG. 31 is a side view of the device as shown in FIG. 29;

FIG. 32 is an isometric view of the device as shown in FIG. 29;

FIG. 33 is an exploded isometric view of the sections of the attachment device shown in FIGS. 25-32 attached to a sprinkler fitting assembly with an associated wall for installation, in accordance with an embodiment of the invention;

FIG. 34 is a side view of the FIG. 33 embodiment in an installed condition;

FIG. 35A is an isometric view of a base plate for a pressed steel embodiment of the invention;

FIG. 35B is a front view of the base plate shown in FIG. 35A;

FIG. 36A is an isometric view of a cover plate for a pressed steel embodiment of the invention;

FIG. 36B is a front view of the cover plate shown in FIG. 36A;

FIG. 37A is an isometric view from the rear of the assembled two piece version of the alternative embodiment of FIGS. 35 and 36 with the encapsulated SFA shown;

FIG. 37B is an isometric view from the front of the assembled two piece version of the alternative embodiment of FIGS. 35 and 36 with the encapsulated SFA shown;

FIG. 38 is an isometric view of the one piece version of the alternative embodiment of FIG. 35 through 37;

FIG. 38A is a top view of the one piece version of the alternative embodiment of FIG. 38;

FIG. 38B is a front view of the one piece version of the alternative embodiment of FIG. 38;

FIG. 38C is a cross sectional side view of the one piece version of the alternative embodiment of FIG. 38;

FIG. 38D is a rear view of the one piece version of the alternative embodiment of FIG. 38; and

FIG. 38E is an isometric view of the one piece version of the alternative embodiment of FIG. 38 with the encapsulated SFA shown.

### DETAILED DESCRIPTION OF EMBODIMENTS OF THE INVENTION

As previously noted, it is a purpose of the embodiments of the present invention to provide a sprinkler fitting attachment device and installation method which improves the known methods of installing pre-assembled, unitary sprinkler fitting assemblies such as that disclosed in U.S. Pat. No. 7,699,117. The preferred embodiments have been developed to coordinate with the preferred embodiment of the sprinkler fitting assembly disclosed in detail in the referenced patent. For illustrative purposes, the detailed description of these embodiments is presented as used with that sprinkler fitting assembly. This description will enable one of ordinary skill in the art of fire protection systems to practice the claimed invention with the sprinkler fitting assembly disclosed in U.S. Pat. No. 7,699,117 or with any other sprinkler fitting assembly of applicable design and structure.

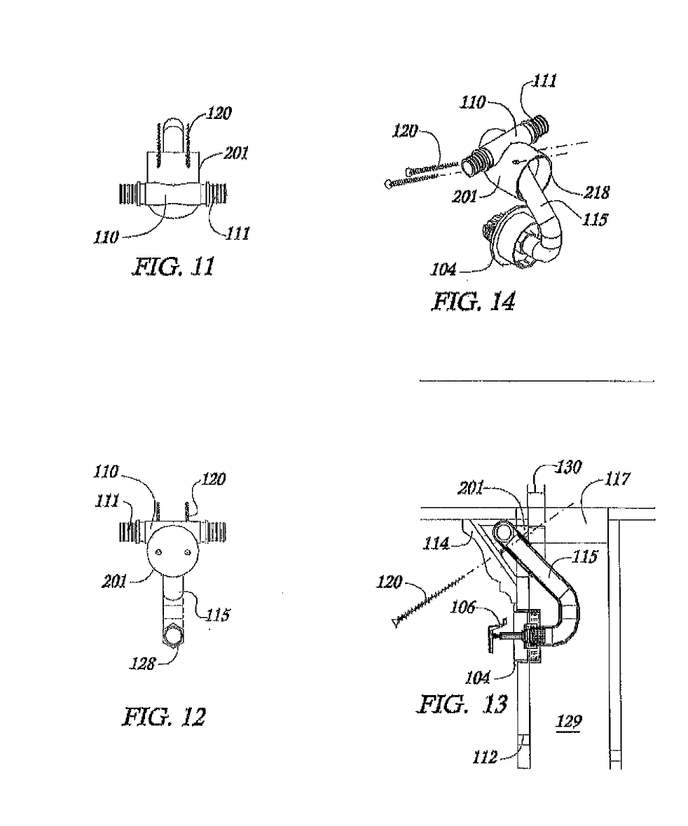

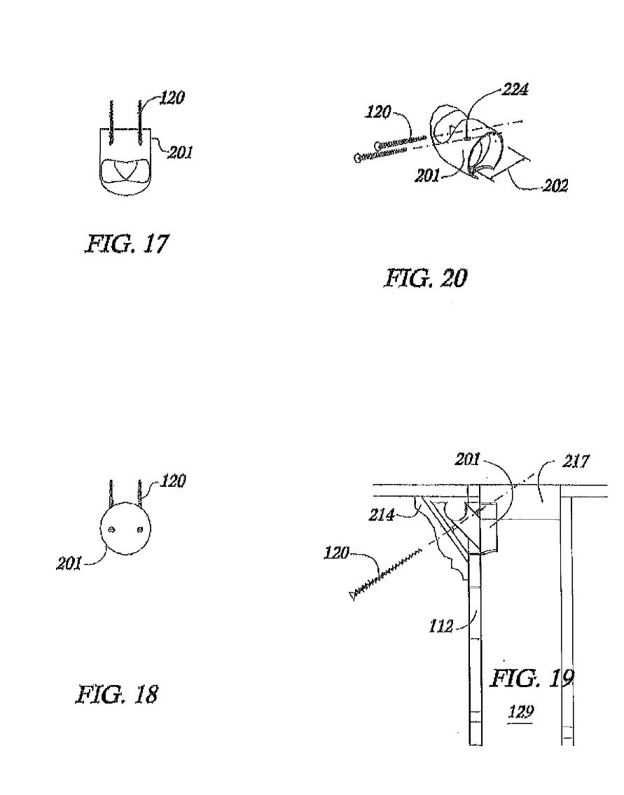

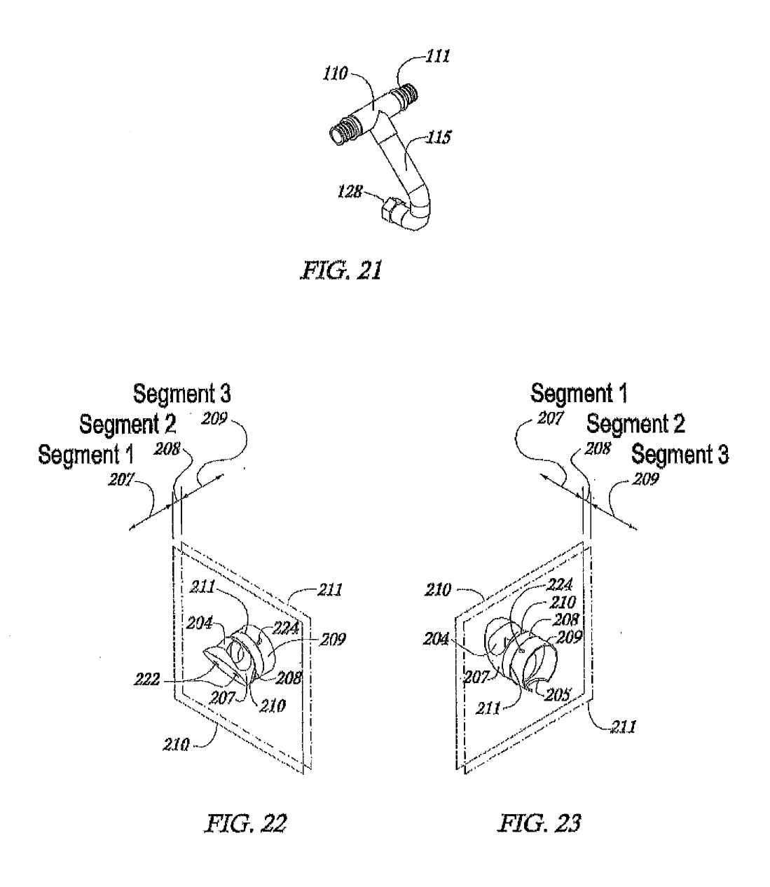

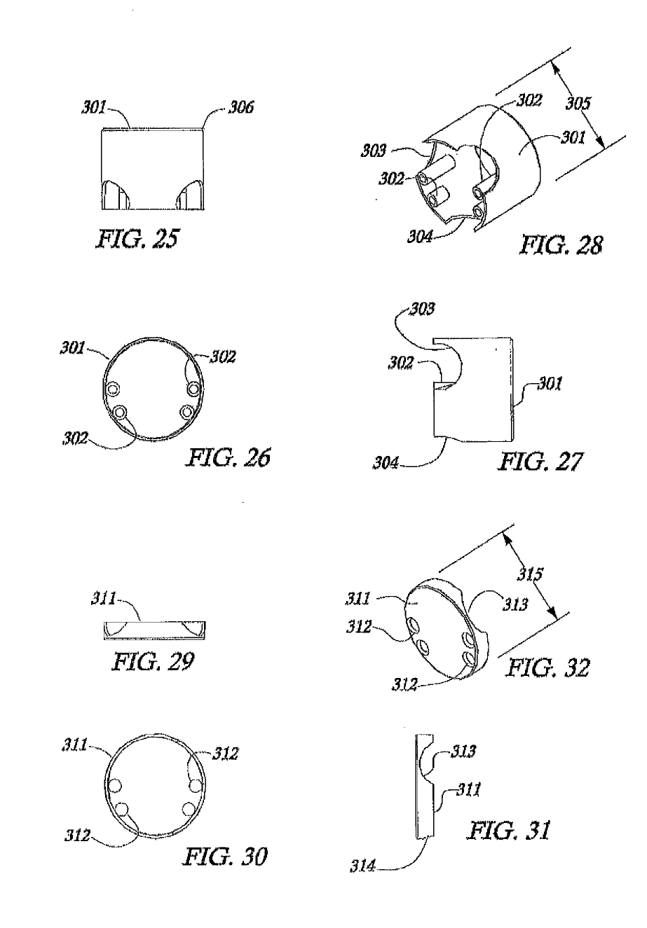

In summary, FIGS. 1-10 and FIG. 15 represent various views of the sprinkler fitting attachment device as created in prototype form using copper pipe materials. FIGS. 11-14, FIGS. 16-20, and FIGS. 22 and 23 represent various views of the sprinkler fitting attachment device as molded in a single monolithic piece from materials such as polyethylene, CPVC (chlorinated polyvinyl chloride), fiberglass, among others. FIGS. 25-34 represent various views of an alternative embodiment of the sprinkler fitting attachment device comprised of multiple pieces to provide alternative installation options.

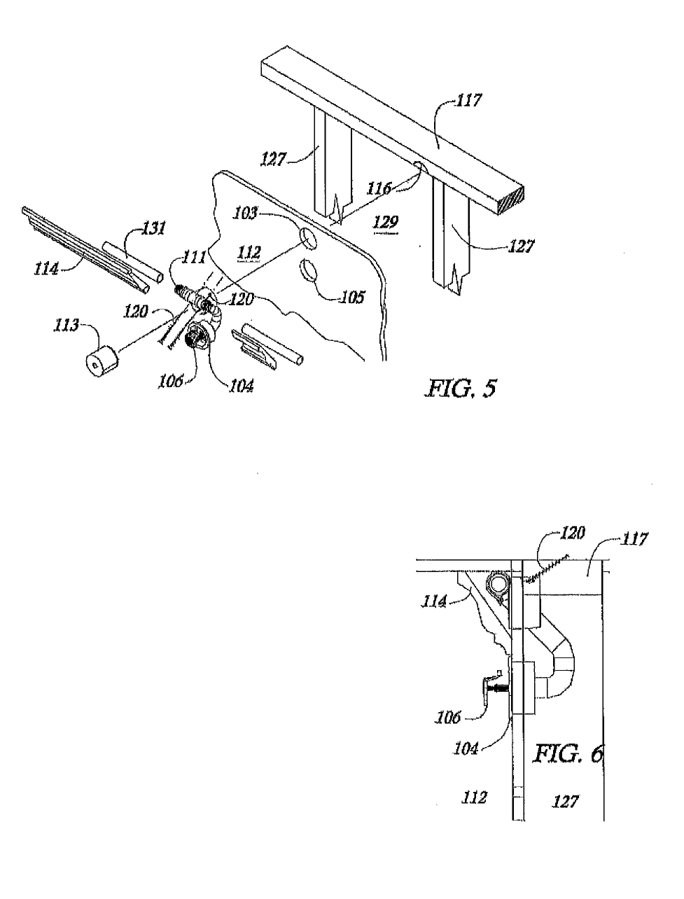

An installation of the preferred embodiment of the sprinkler fitting attachment device (hereinafter abbreviated “SFAD”) employed in conjunction with an installation of the sprinkler fitting assembly (hereinafter “SFA”) as described in U.S. Pat. No. 7,699,117 (hereinafter the “'117 patent”) and shown in FIGS. 1-6 of the '117 patent, is shown assembled with an SFA in FIG. 6 and installed in a typical residential wall in FIG. 9. For illustrative purposes, the wall is shown having one vertical surface member 112 fabricated from drywall or other suitable material and having an interior structural top plate 117 fabricated from construction lumber or other suitable material.

Referring now to FIGS. 1-6, a preferred embodiment of the SFAD has a cylindrical shape 101 with an outer diameter that generally matches the diameter of an installation hole 103 (FIG. 3) which is typically based on the size of the sprinkler escutcheon 104 to be used (generally about 2¼″). The completed SFA and SFAD (FIG. 4) will be installed using two holes 103 and 105. It is preferable that the two holes be of the same size (reducing the number of tools required). Since the lower hole 105 must accommodate the sprinkler 106 and its associated escutcheon 104, the size of both holes is thus determined by the size of the sprinkler escutcheon. For proper functioning of the SFAD its outer diameter should match the diameter of upper installation hole 103.

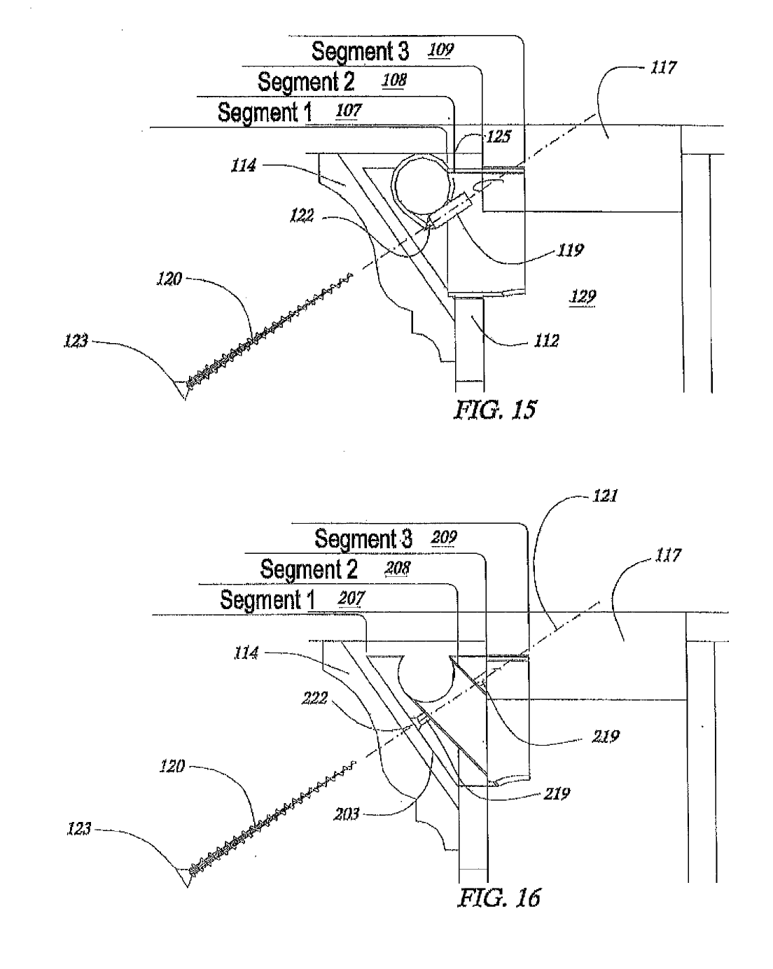

In the preferred embodiment, three segments can be defined along the length of this cylindrical shape. All three segments have the same outer diameter and form a contiguous single shape. With reference to FIG. 15, Segment 1 107 engages SFA 110 along a section between the pipe connectors 111. This segment is provided with one or more generally cylindrical bands 134 (FIG. 10) sized to firmly engage the SFA between the pipe connectors. Segment 2 108 mates with the first segment at one end and with Segment 3 109 at the other end and resides entirely within the hole through wall 112. Typically holes 103 and 105 are drilled into the existing residential wall 112 using hole saw 113 (FIG. 5). The third segment mates with the second segment and is pipe shaped with a wall thickness to match the kerf of the hole saw.

As shown in FIG. 15, segment 107 can be solid or pipe shaped or any other convenient shape and its outer end is relieved along sloped plane 203 to fit behind crown molding 114 used to conceal the SFAD and SFA installation. The length of segment 107 is sufficient to insure contact and secure connection to the SFA, particularly that section of the SFA between the pipe connectors and the sprinkler fitting main conduit (approximately ⅛″ to 1″). Furthermore, for the purpose of installation, segment 107 can be separated into two or more pieces. For example, band 134 may attach to the segment with machine screws.

Segment 108 can be solid or pipe shaped and is relieved as necessary to accommodate main conduit 115 of the SFA. The length of segment 108 is approximately equal to the thickness of the wall material (generally ⅜″ to ⅝″ drywall) making up wall 112.

Segment 109 is solid or preferably pipe shaped and is relieved as necessary to accommodate main conduit 115 of the SFA. The preferable pipe shape of segment 109 easily accommodates its installation into channel 116 created in wall top plate 117 by the use of hole saw 113 (FIG. 5). A solid shaped segment 109 would require the use of a tool such as a Forstner drill bit to remove sufficient material from the wall top plate to accommodate the solid shape. Open end 118 of a pipe shaped segment 109 can be chamfered to facilitate the installation process. The length of segment 109 is defined by the depth of engagement into the wall top plate 117 desired for mechanical stability and would typically be approximately ½″.

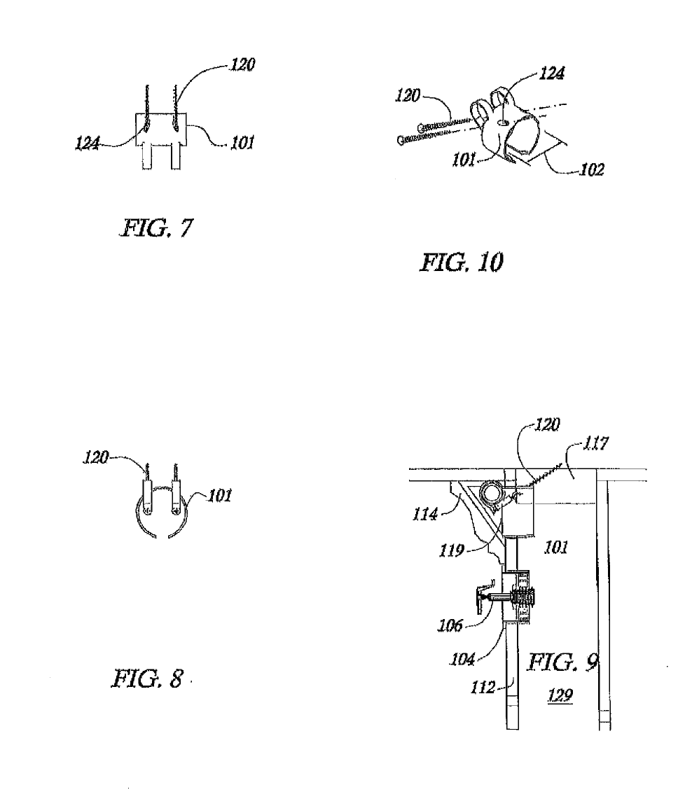

The overall length of this preferred embodiment of the SFAD is the sum of the lengths of the three segments as described above. The SFAD, in some embodiments, also includes one or more cylindrical guide channels 119 to enable the installation of multi point connections along the length of the SFAD using one or more fastening devices 120 to prevent pivoting of the fitting at the connection to wall top plate 117 and to guide the fastening devices to the wall top plate. Each guide channel passes through the cylindrical shape, past sprinkler fitting main conduit 115 and below the section of SFA 110 between the pipe connectors. Each such channel is of sufficient length to define the path of suitable fastening devices. Suitable fastening devices include screws, nails, and lag bolts, among others. The maximum length of the cylindrical guide channels is further determined by the dimensions of segments 107 and 108 described above. Alternatively the maximum length of the channels can be specified as originating at the outermost end of segment 107, passing through the interface of segments 107 and 108 and terminating at the interface of segments 108 and 109. Accordingly, the guide channels do not protrude into segment 109 to prevent interference with the wall top plate and do not protrude past the outermost end of segment 107 to prevent interference with crown molding 114 which may be used to conceal the installation. Path 121 of the guide channels is angled upwardly from the horizontal and targeted to the wall top plate. The entry point 122 (FIG. 15) of each guide channel is recessed to provide clearance between heads 123 of the fastening devices and the final installation of crown molding 114. The size and shape of the fastening devices and guide channels are complimentary. For each guide channel 119 there is a corresponding hole 124 (FIGS. 7 and 10) in segment 109 of the SFAD. Each such hole is sized and located to provide a continuous, complimentary path for the fastening device through the associated guide channel.

The entire SFAD, including the guide channels as described above, is positioned in relationship to the SFA so as to be aligned with the upper installation hole of the SFA when it is installed. The SFAD, including the guide channel, is rigidly, securely, and permanently attached to the SFA so as to become an integral part of the unitary nature of that fitting. This rigid attachment may be accomplished as part of the fabrication process for an entire unitary SFA/SFAD assembly. Alternatively, the SFAD may be rigidly attached to the SFA during the installation process. In the latter instance, segment 107 of the SFAD may itself be comprised of two parts. One part would be integral to the contiguous shape described above (comprised of segments 107, 108, and 109). The second part would be initially detached from the rest of the segments to allow for a two step installation method in which the SFA would be securely, permanently, and rigidly encapsulated between the two parts of segment 107 at the time of final installation of the SFA.

Materials appropriate for the construction of the SFAD include but would not be limited to: copper, brass, cold rolled steel, galvanized steel, stainless steel, aluminum, CPVC, cross linked polyethylene (PEX-A), hard rubber or fiberglass reinforced resin. The choice of a particular material will be affected by the embodiment of this invention employed and by the materials used for the SFA. For example, if the SFA is formed from copper piping then the SFAD would likely be manufactured from brass, copper or plastic to avoid corrosion generated by the contact of dissimilar metals.

This preferred embodiment of the sprinkler fitting attachment device can be better understood by describing the final installation position of the entire SFA, including the SFAD, at a typical wall and ceiling junction 125 as shown in FIG. 3. Ceiling 126 has a horizontal flat surface which defines a room's upper boundary and the upper boundary for the installation of the SFA. Wall 112 is comprised of a vertical flat surface formed over structural members. The structural members include vertically mounted studs 127 spaced horizontally and attached at the bottom by a horizontally positioned floor plate and at the top by horizontally positioned top plate 117. The position of the top plate is in close proximity to the wall ceiling junction 125. The top plate has sufficient structural strength to provide for a secure and rigid attachment of the SFA. The wall and ceiling surfaces themselves may not have sufficient structural strength to provide for a secure and rigid attachment of the SFA.

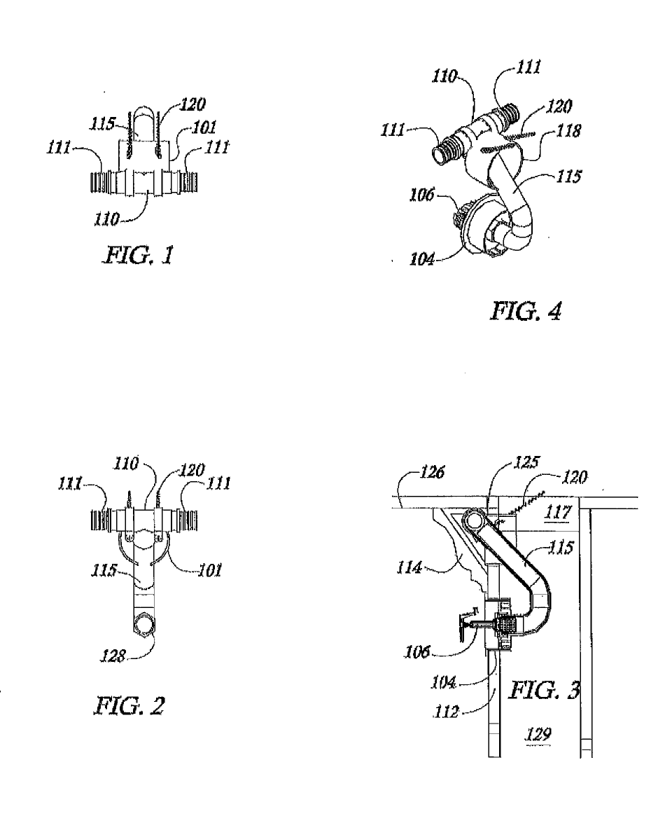

As disclosed in the '117 patent, the SFA installation requires the creation of two holes in the wall 112. The upper hole or aperture 103 is formed in close proximity to the wall ceiling junction and the lower aperture 105 is spaced vertically below and generally aligned with the upper aperture. Both apertures are of sufficient size to accommodate the respective ends of the SFA. In the presently described preferred embodiment, the size of upper aperture 103 is selected to permit insertion of the SFAD into the wall. Second segment 108 of the SFAD resides entirely within upper aperture 103 in wall 112. The upper aperture is further defined by its projection into wall top plate 117. When the upper aperture is formed using hole saw 113, a cylindrically shaped channel 116 is created in the top plate whose size and shape are complementary to the SFAD. The entire wall top plate channel 116 is occupied by pipe shaped segment 109 of the SFAD. This brings the SFAD into close contact with the structural top plate, thus providing stability and rigidity for the entire SFA. Positioning of SFAD into the channel is facilitated by chamfering of the leading edge 118 of segment 109. In an alternative configuration, a solid cylindrically shaped segment 109 brings the SFAD into close contact with the structural top plate. The final positioning of the SFAD in the wall top plate insures proper alignment of the SFA. In particular, the sprinkler adapter outlet 128 (FIG. 2) is thus aligned concentrically with lower aperture 105 and the depth of the sprinkler adapter outlet relative to wall 112 is properly set to provide for required compliance with sprinkler manufacturer installation specifications.

Once positioned in the above described manner, fastening devices 120 are installed through the fastening guide channels 119 to provide a permanent attachment of the SFA to the structural wall top plate. Once secured in this fashion, standard crown molding 114 is installed at the wall-ceiling junction to conceal the entire top portion of the SFA.

The SFAD can be further described by means of review of an installation process for the entire sprinkler fitting assembly, including the sprinkler fitting attachment device, at wall-ceiling junction 125. Typically, the process begins with the selection of a rough location for the sprinkler. This location is usually guided by a design layout of the entire sprinkler system on a construction plan applying sprinkler design and installation standards. A specific location is further selected by locating an unobstructed path close to the wall-ceiling junction and within the adjacent wall cavity 129. Such a location is commonly found between an adjacent pair of wall studs 127. Hole saw 113 of sufficient diameter to accommodate clear passage of the SFAD is then used to drill an upper installation aperture 103 in wall 112. Use of hole saw 113 for this operation is preferable because it causes a minimum of drywall dust and simultaneously creates an arc shaped channel 116 into wall top plate 117. In drilling this aperture, it is desirable to match the length of the arc shaped channel 116 to the SFAD so as to provide contact between the end of segment 109 of the SFAD and the end of the channel in the wall top plate. Alternatively, the hole into the wall top plate can be formed with a tool such as a Forstner drill bit to form a square ended hole to accommodate a solid shaped segment 109 of the SFAD.

It is preferable to validate the location of the upper installation aperture 103 prior to drilling the lower installation aperture 105. If the upper installation aperture is found to be in an unsuitable location, it is easily relocated with no need for any patching or painting whereas relocating the lower installation aperture would require patching and painting. Once the upper aperture is complete, the lower aperture will be located directly below that aperture. A centerline passing vertically through the lower aperture will align with a centerline passing vertically through the upper aperture. A centerline passing horizontally through the lower aperture will be located below wall-ceiling junction 125 by a distance determined by the dimensions of the SFA so as to provide a proper location of the sprinkler head in accordance with accepted sprinkler standards and sprinkler manufacturer specifications (typically 4″-6″ below the wall-ceiling junction). Hole saw 113 (preferably the same hole saw as used for the upper aperture) can then be used to drill a hole through the drywall to form the lower aperture.

Installation then proceeds by inserting the SFA, sprinkler adapter 128 end first, into the upper aperture 103. The SFA is inserted until the sprinkler adaptor end aligns with the lower aperture 105. This operation involves a simultaneous insertion and rotation procedure to produce the desired positioning of the sprinkler fitting assembly. When the sprinkler adaptor end of the SFA is aligned with the lower aperture, the SFAD will be roughly aligned with the upper aperture. The installation process continues by further aligning the end of the sprinkler fitting attachment device 118 with the channel 116 or square ended hole in the top plate 117 and firmly and completely seating it into that channel or square ended hole.

Alternatively, the installation may proceed by aligning the independent portion of SFA 118 with channel 116 or square ended hole in top plate 117 and firmly and completely seating it into that channel or square ended hole. The installation then proceeds by inserting the sprinkler fitting assembly (SFA) sprinkler adapter end 128 first into upper aperture 103. The sprinkler fitting assembly is further inserted until the sprinkler adaptor end aligns with lower aperture 105. This operation involves a simultaneous insertion and rotation procedure to produce the desired positioning of the SFA. When the sprinkler adaptor end of the SFA is aligned with the lower aperture, the parts of the SFAD will be roughly aligned at the upper aperture.

Then while maintaining alignment of the sprinkler adaptor with the lower aperture, fastening attachment devices 120 (such as 3″-4″ dry wall screws) are inserted into the attachment channels and driven into the wall top plate, securely providing a permanent location of the sprinkler fitting assembly. Preferably, the length of the fastening attachment devices is chosen to fully engage the wall top plate to maximize the strength of the installation.

The installation process continues with the attachment of sprinkler pipes 131 to pipe connectors 111 at the ends of the SFA. A decorative crown molding 114 is then installed using conventional construction methods at the wall-ceiling junction to completely conceal the sprinkler piping, the SFAD and the upper portion of the SFA. Finally, a sprinkler head 106 and its associated escutcheon 104 are secured in place into the sprinkler adaptor 128 end of the SFA. This provides fluid connection of the sprinkler head to the piping system. The sprinkler head and its associated escutcheon completely conceals the lower installation aperture 105. Completion of the installation of the sprinkler fitting assembly and its associated sprinkler fitting attachment device thus provide a proper location for the sprinkler head which is both secure and rigid.

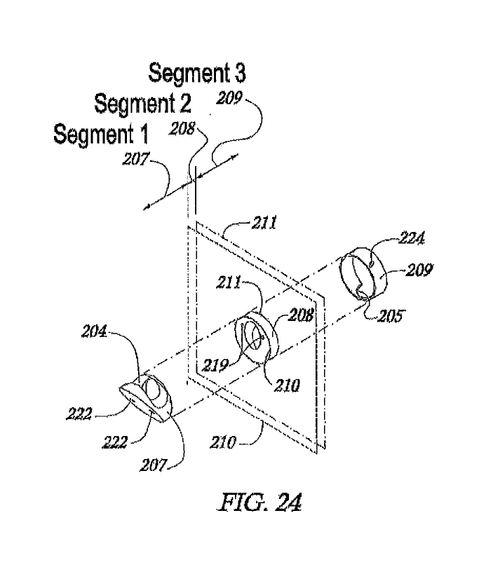

An alternative embodiment is shown in FIGS. 11, 12, 14, and 16. In this configuration, segments 207, 208, and 209 are fabricated as pieces molded from a suitable material. Suitable materials include polyurethane, CPVC, hard rubber, and glass-filled epoxy. Instead of the generally cylindrical bands 134 used to engage the SFA as described above, the molded segment 207 is provided with a relief which matches the shape of the SFA as shown in FIG. 14. The sizes and functionality of segments 208 and 209 are substantially similar or identical to that described in detail above for segments 108 and 109. For this configuration, the guide channels 219, 222, and 224 (FIGS. 20, 22, 23, 24) provided for use with attachment devices 120 are simply clearance passageways drilled appropriately into the molded segments after their fabrication or formed as part of the molding process. The installation procedure and method of attachment of the SFAD and SFA to a wall using this configuration of the preferred embodiment of the SFAD with an SFA is essentially identical to that described above.

A second embodiment of the invention is shown in FIGS. 25-33. For this embodiment, the SFAD is comprised of two sections 301 and 311. These sections may be fabricated by machining from a material such as a metal or hard plastic. Alternatively, the sections may be fabricated using a molding process or any other suitable manufacturing process such as stereo-lithographic resin printing. Both sections are cylindrical in cross-section with diameters which generally match the diameter of the installation aperture 103 and fit together to form a contiguous single shape. Installation aperture 105 may have diameter substantially the same as aperture 103 for convenience. Moreover, wall top plate 117 is provided with channel 116 formed when aperture 103 is created, typically using hole saw 113.

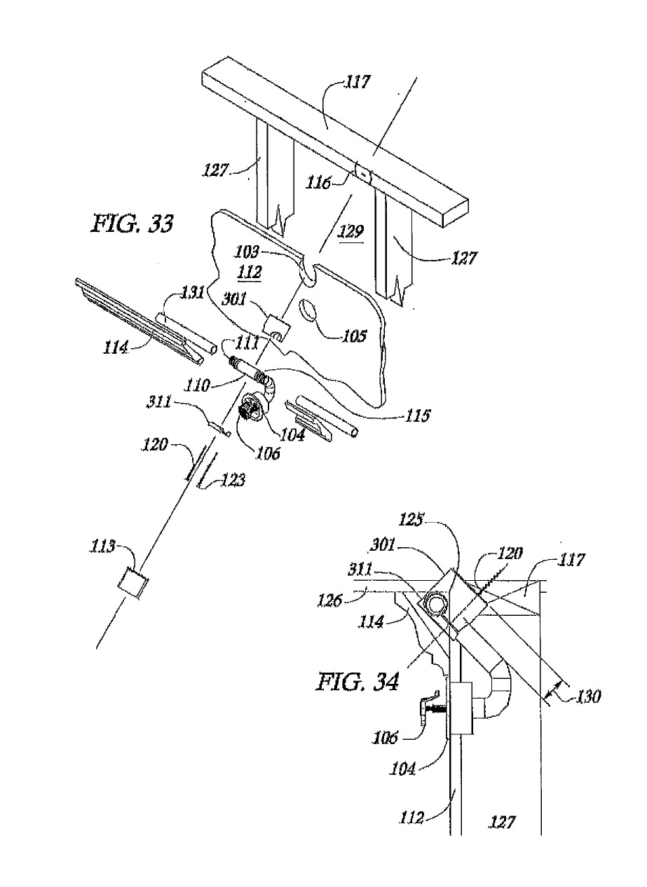

Sections 301 and 311 may be solid or pipe shaped. They are provided with reliefs 303 and 313, respectively, which are shaped and sized to substantially match the shape and size of the main conduit of the SFA to be used in an installation. Sections 301 and 311 are provided with guide channels 302 and 312 respectively which are positioned and angularly oriented so that each guide channel 302 aligns with a corresponding guide channel 312 to accommodate the insertion of fasteners 120 and 123 through both sections to engage wall top plate 117 when installed as shown in FIG. 33. The location and shape of the reliefs 303 and 313 are selected to accommodate the main conduit 115 of the SFA when sections 301 and 311 are installed as shown in FIG. 33. The depth of relief 313 is preferably one-half the diameter of main conduit 115. Moreover, the size and shape of the reliefs 303 and 311 are selected to that the main conduit of the SFA is firmly clamped between sections 301 and 311 when they are installed as shown in FIG. 33 and fasteners 120 and 123 fully engaged with top plate 117.

For installation of the SFA and SFAD assembly, sections 301 and 311 are placed over the main conduit portion of the SFA so that the guide channels of the two sections are aligned. The combined assembly is inserted, sprinkler adapter 128 end first, through the aperture 103, and with a rotational motion, positioned so that the sprinkler adapter 128 is aligned with aperture 105 and so that section 301 is fully inserted through aperture 103 and fully seated in channel 116 of top plate 117. Once positioned, fasteners 120 and 123 are installed to rigidly attach the entire assembly to the top plate 117. For example, if fasteners 120 and 123 are wood screws, this step involves drilling of pilot holes into the top plate through the guide channels 302 and 312 followed by the screwing in of the fasteners so that they are fully seated. The sprinkler escutcheon is then placed into aperture 105 and sprinkler 106 is installed onto the sprinkler adapter 128, completely concealing aperture 105. Installation of crown molding 114 will then conceal the SFAD and SFA assembly and aperture 103.

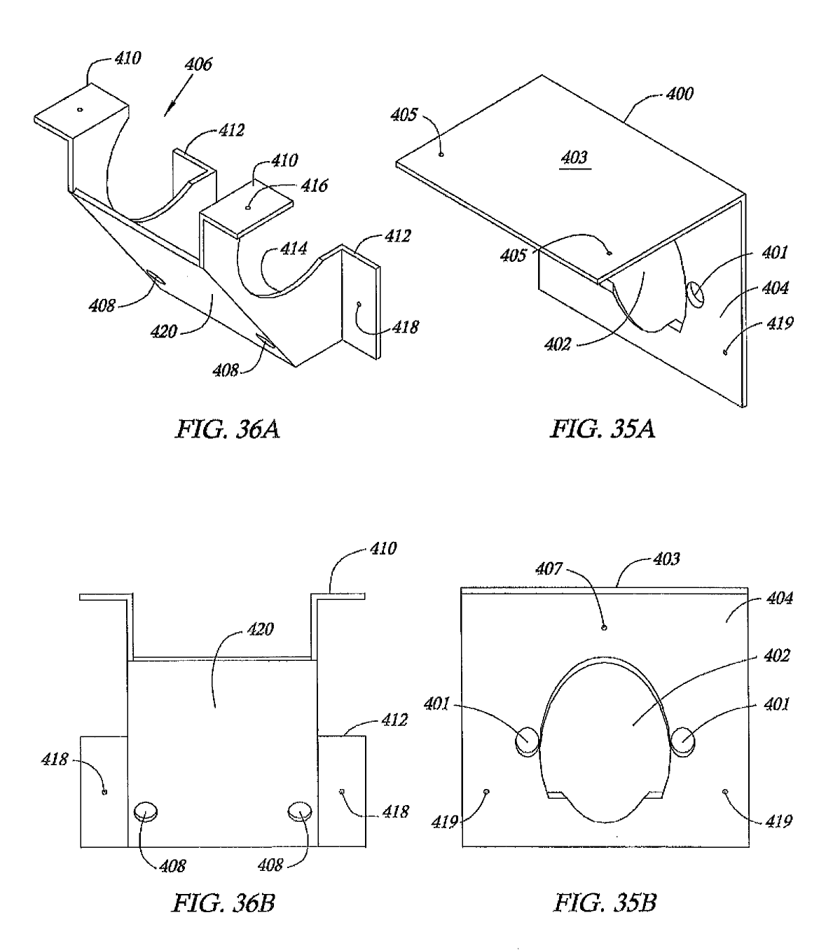

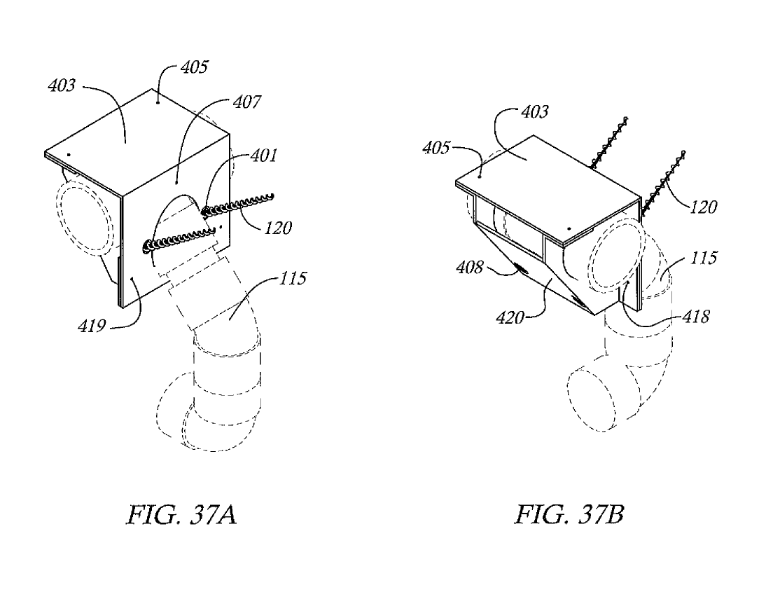

Two further alternative embodiments are shown in FIGS. 35, 36, 37, and 38. These embodiments are constructed using pressed steel structures which can offer significant manufacturing cost savings. A two piece embodiment is shown in FIGS. 35A, 35B, 36A, 36B, 37A, and 37B. The first piece, identified as base plate 400, is fabricated from pressed steel in the form of a right angle having top surface 403 and side surface 404. This base plate is installed at the wall-ceiling junction and temporarily held in place at the wall-ceiling junction by means of a fastener such as a nail or screw to compliment hole 407 (FIGS. 35B and 37A) through which the aforementioned nail or screw is inserted. The side surface has a clearance port 402 sized to provide clear access to hole 103 in the wall to receive the SFA and prevent rotation of the SFA once the SFA reaches its final installed position. It is also provided with two holes 401 through which fasteners 120 can be passed. Base plate 400 is also provided with a number of clearance holes 405 and 419 to enable a cover plate 406 to be riveted to base plate 400 forming a single unit which is positioned at the wall ceiling junction and held permanently and securely in place by fasteners 120 passing through two holes 401 and preventing all up and down, in and out and rotational movement of the SFA in its final installed position.

The second piece of this embodiment is cover plate 406 which is installed after the base plate is in place and an SFA has been inserted through hole 103 to its final location. Cover plate 406 is placed against base plate 400 and then riveted to base plate 400 through several holes 405 and 416 encapsulating the SFA, Clearance holes 416 and 418 in flanges 410 and 412, respectively, may be used with small nails to hold the cover plate in place during this step. Arcuate cutouts 414 engage portions of the SFA. Fasteners 120 then pass through clearance holes 408 in the cover plate and through clearance holes 401 in the base plate and into the top plate of the wall internal structure.

Alternatively, base plate, SFA and cover plate can all be preassembled to form a unitary assembly as shown in FIG. 37B prior to installation at the wall ceiling junction. Main conduit 115 of the SFA is passed through base plate 400 and arcuate cutout 402 is specifically shaped to intimately engage main conduit 115 and prevent all SFA rotational movement. The SFA is prevented from all up and down and in and out movement by encapsulating it within cover plate 406 riveted to base plate 400 by means of several holes 416 and 418 in cover plate 406 aligned with holes 405 and 419 respectively in base plate 400 and securely and permanently attaching the entire assembly to the building structure with fasteners 120 through holes 408 in the cover plate and holes 401 in the base plate. This process pulls the cover plate and base plate assembly firmly into the wall-ceiling junction and clamps the SFA firmly to the pressed steel structure. Angled surface 420 is parallel with the crown molding which is applied later.

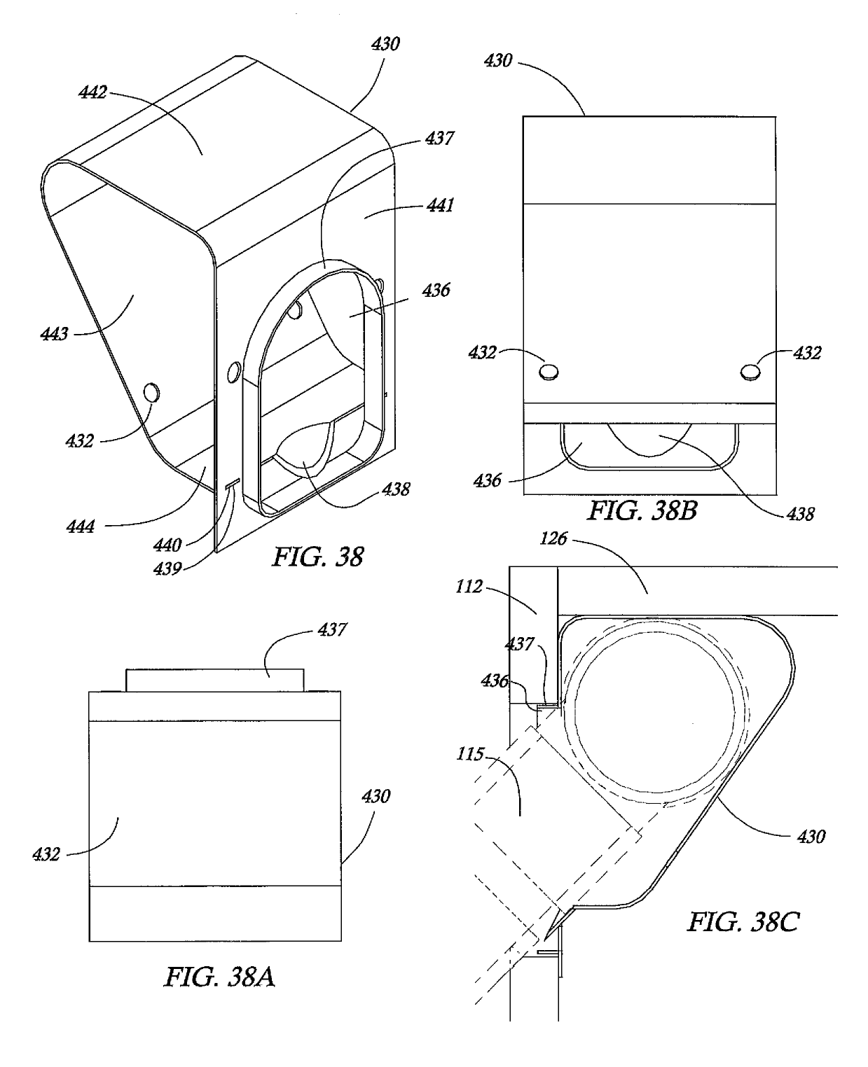

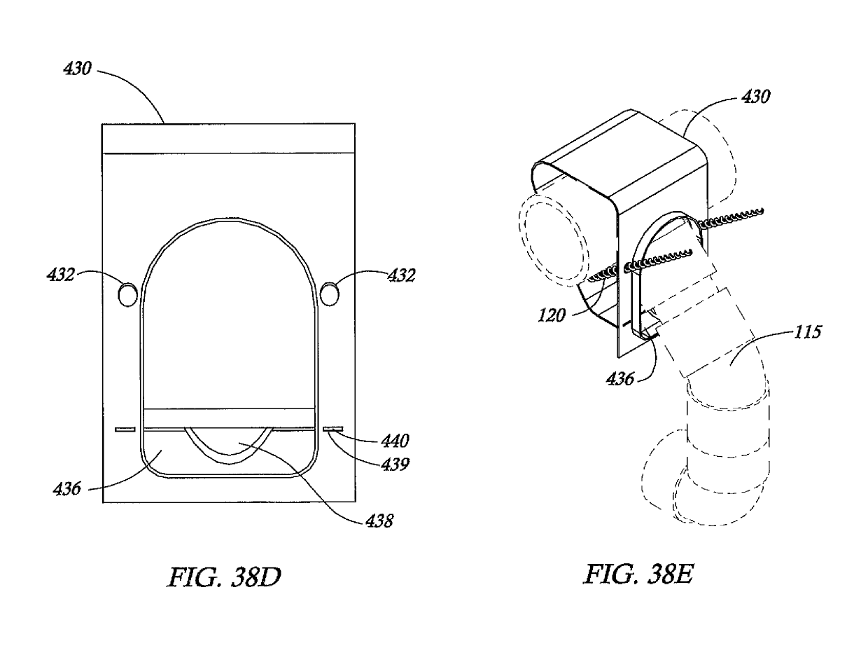

Another alternative pressed steel embodiment of the invention implements a one-piece design which integrates the base plate and cover plate of FIGS. 35-37 into a single pressed steel structure 430, as seen in FIG. 38. This embodiment employs a single piece pressed steel bracket that incorporates the features of the two piece design of FIGS. 35-37 without the need for connecting the two separate pieces during fabrication or installation. The one piece version can best be described when divided into four distinct but contiguous segments 441, 442, 443, and 444. First segment 441 is a flat vertical plate that resides against vertical surface member (wall) 112 and is sized to accommodate opening 436, holes 432, and slots 439. Opening 436 is enhanced in its entirety by flange 437 and mates at its uppermost end with second segment 442. The second segment is a flat horizontal plate which resides against ceiling 126 and mates to angled third segment 443. The third segment contains holes 432 and continues diagonally downward and inward to mate with fourth segment 444. The fourth segment is enhanced by lip 438 and tabs 440 which are inserted into slots 439 of segment 441. Lip 438 is shaped so as to compliment and support the bottom of main conduit 115 of the SFA. As part of the assembly process the SFA will be passed through opening 436 before tabs 440 are inserted into slots 439. Curved transitions between segments 441 and 442 and between segments 442 and 443 provide sufficient flexibility to open the structure allowing insertion of the SFA into opening 436. The structure can subsequently be closed and held in the closed position by the insertion of tabs 440 into slots 439. This operation will create a unitary assembly with sufficient integrity for shipping, handling, and installation while permanent closure of the structure is accomplished by the installation of fasteners 120 at the time of final installation.

This embodiment, like the previous one, is particularly well suited for use with SFA's constructed of materials such as CPVC or PEX (cross-linked polyethylene). Those materials, while providing adequate strength to form the necessary water tight channel for the required flow of water, are not necessarily strong enough to provide the required structural connection of the fitting assembly to the building structure. The means of providing that structural connection is provided in these two embodiments by encapsulation of the SFA rather than by the physical attachment of the SFAD to the SFA.

In the two piece version represented in FIGS. 35-37, the encapsulation is accomplished through the clearance contact between the SFAD and the SFA at three essentially circular places. These are at the two arcuate cutouts 414 in the cover plate in conjunction with the base plate 400 and the elliptical cutout 402 in the base plate. The two arcuate cutouts prevent any horizontal or vertical motion of the encapsulated SFA in any direction perpendicular to the axis of the piping at the wall ceiling junction. The elliptical cutout in the base plate prevents any rotation of the SFA about the axis of the piping at the wall ceiling junction.

In the one piece version represented in FIG. 38, the encapsulation is accomplished through the clearance contact between the SFAD and the SFA at two generally circular places. The first circular place is formed by the first three segments 441, 442 and 443 of the SFAD that encapsulate and surround the section of the SFA between the pipe connectors. The second essentially circular place is the elliptical place formed by cutout 436 on the first (vertical back) segment 441 of the SFAD and lip 438 formed into the last (horizontal bottom) segment 444 of the SFAD. The essentially circular place formed by the first three segments of the SFAD prevent any horizontal or vertical motion of the encapsulated SFA in any direction perpendicular to the axis of the piping at the wall ceiling junction. Cutout 436 on the first (vertical back) segment of the SFAD in conjunction with lip 438 formed in the last (horizontal bottom) segment 444 of the SFAD prevent any rotation of the SFA about the axis of the piping at the wall ceiling junction. Once prepared, the entire assembly comprising the SFA and this embodiment of the SFAD is placed at the wall-ceiling junction and fasteners 120 are installed into the top plate of the wall internal structure through clearance holes 432 to permanently, rigidly and securely attach the SFA to the building.

While particular embodiments of the present invention have been disclosed, it is to be understood that various different modifications and combinations are possible and are contemplated within the true spirit and scope of the disclosed embodiments. There is no intention, therefore, of limitations to the exact disclosures herein presented.

What is claimed is:

1. A device for attaching a fire protection sprinkler fitting assembly in a building at a wall-ceiling junction, the wall having an internal space and an internal structure, the fire protection sprinkler assembly having a unitary, pre-assembled fitting shaped and configured to reside within the wall internal space with a first end extending into a first hole in the wall and a second end extending into a second hole in the wall, said second end being configured to receive a sprinkler head, said first end having a coupling configured to engage at least one end of a pipe for fluid communication from said pipe to said second end of said fitting, the internal structure of the wall having a top plate, the device comprising:
a means for attachment of the device to the fire protection sprinkler fitting assembly; and
at least one guide channel for guiding the installation of a fastening device, wherein the fastening device fastens the means for attachment to the top plate of the internal structure of the wall.

2. The device according to claim 1, wherein said means for attachment of the device of the fire protection sprinkler assembly includes at least two spaced substantially cylindrical bands attached to the device, the bands enclosing and clamping portions of the fire protection sprinkler assembly to prevent rotational and translational movement of the fire protection sprinkler assembly relative to the device.

3. The device according to claim 1, wherein said attachment means comprises at least two separable segments, each segment having at least two guide channels and a relief, the location, size, and orientation of said guide channels and said reliefs being selected to enable a portion of the fire protection sprinkler assembly to be clamped between said segments, said fastening device comprising elongated fasteners, whereby said fasteners are inserted through said guide channels in both segments and fasten the device to the top plate of the wall internal structure, thereby preventing rotational and translational movement of the sprinkler fitting assembly relative to the wall internal structure without permanently fusing the separable segments to the SFA.

4. The device according to claim 1, wherein the device is formed with two guide channels.

5. The device according to claim 1, wherein a portion of said attachment means is configured to be inserted through an aperture in the wall to engage a channel within the top plate of the wall structure.

6. The device according to claim 1, wherein said attachment means attaches the fire protection sprinkler fitting assembly to the wall-ceiling junction such that a sprinkler adaptor portion of the fire protection sprinkler fitting assembly is positioned in a second aperture of the wall to enable installation of a sprinkler head onto the sprinkler adaptor from outside the internal structure of the wall.

7. The device according to claim 5, wherein said attachment means attaches the fire protection sprinkler fitting assembly to the wall-ceiling junction such that a sprinkler adaptor portion of the fire protection sprinkler fitting assembly is positioned in a second aperture of the wall to enable installation of a sprinkler head onto the sprinkler adaptor from outside the internal structure of the wall.

8. The device according to claim 2, wherein a portion of the device is configured to be inserted through an aperture in the wall to engage a channel within the top plate of the wall internal structure.

9. The device according to claim 2, wherein said attachment means attaches the fire protection sprinkler fitting assembly to the wall-ceiling junction such that a sprinkler adaptor portion of the fire protection sprinkler fitting assembly is positioned in a second aperture of the wall to enable installation of a sprinkler head onto the sprinkler adaptor from outside the internal structure of the wall.

10. The device according to claim 8, wherein said attachment means attaches the fire protection sprinkler fitting assembly to the wall-ceiling junction such that a sprinkler adaptor portion of the fire protection sprinkler fitting assembly is positioned in a second aperture of the wall to enable installation of a sprinkler head onto the sprinkler adaptor from outside the internal structure of the wall.

11. The device according to claim 3, wherein a portion of the device is configured to be inserted through an aperture in the wall to engage a channel within the top plate of the wall internal structure.

12. The device according to claim 3, wherein said attachment means attaches the fire protection sprinkler fitting assembly to the wall-ceiling junction such that a sprinkler adaptor portion of the fire protection sprinkler fitting assembly is positioned in a second aperture of the wall to enable installation of a sprinkler head onto the sprinkler adaptor from outside the internal structure of the wall.

13. The device according to claim 11, wherein said attachment means attaches the fire protection sprinkler fitting assembly to the wall-ceiling junction such that a sprinkler adaptor portion of the fire protection sprinkler fitting assembly is positioned in a second aperture of the wall to enable installation of a sprinkler head onto the sprinkler adaptor from outside the internal structure of the wall.

14. A method for attaching a fire protection sprinkler fitting assembly in a building at a wall-ceiling junction, the wall having an internal space and an internal structure, the fire protection sprinkler assembly having a unitary, pre-assembled fitting shaped and configured to reside within the wall internal space with a first end extending into the first hole in the wall and a second end extending into the second hole in the wall, said second end being configured to receive a sprinkler head, said first end having a coupling configured to engage at least one end of a pipe for fluid communication from said pipe to said second end of said fitting, the internal structure of the wall having a top plate, the method comprising:
fabricating a structure to which the fire protection sprinkler fitting assembly is able to be clamped, the structure having at least two guide channels for guiding fasteners;
drilling a first aperture through a surface of the wall, the aperture size selected to permit the clear insertion of a portion of the structure and the aperture location selected so that fasteners inserted into the guide channels will engage the top plate when the structure is inserted into the aperture;
drilling a second aperture through the surface of the wall, the second aperture location selected to align with the sprinkler adaptor portion of the fire protection sprinkler fitting assembly when the structure is inserted into the first aperture, the size of the second aperture selected to enable attachment of a sprinkler head to the sprinkler adaptor;
inserting the structure to which the fire protection sprinkler assembly is able to be clamped through the first aperture and positioning the structure so that the sprinkler adaptor is located within the second aperture;
inserting fasteners through the guide channels;
installing the fasteners into the top plate and thereby clamping the fire protection sprinkler fitting assembly to the structure;
installing an escutcheon into the second aperture;
installing a sprinkler head onto the sprinkler adaptor; and
installing crown molding at the wall-ceiling junction to conceal the structure, the first aperture, and portions of the sprinkler assembly.

15. The method of claim 14, wherein the structure to which the fire protection sprinkler fitting assembly is clamped includes at least two substantially cylindrical bands attached to the structure, the bands enclosing and clamping portions of the sprinkler fitting assembly to prevent rotational or translational movement of the sprinkler fitting assembly relative to the structure.

16. The method of claim 14, wherein the structure to which the fire protection sprinkler fitting assembly is clamped contains at least two separable segments, each segment having at least two guide channels and a relief, the location, size, and orientation of the guide channels and the reliefs being selected to enable a portion of the fire protection sprinkler fitting assembly to be clamped between the segments when fasteners are inserted through the guide channels in both segments and fasten the device to the top plate of the wall structure, thereby preventing rotational or translational movement of the sprinkler fitting assembly relative to the structure.

17. The device according to claim 1, wherein the means for attachment includes at least one pressed steel structure capable of encapsulating the SFA to prevent rotational or translational movement of the SFA relative to the structure.

18. The device of claim 17, wherein the means for attachment includes a unitary pressed steel structure capable of encapsulating the SFA to prevent rotational or translational movement of the SFA relative to the structure.
